(19) United States
(12) Patent Application Publication
(10) Pub. No.: US 2023/0145880 A1
(43) Pub. Date: May 11, 2023

(54) METHOD FOR PREDICTING GEOLOGICAL FEATURES FROM IMAGES OF GEOLOGIC CORES USING A DEEP LEARNING SEGMENTATION PROCESS

(71) Applicant: SHELL OIL COMPANY, Houston, TX (US)

(72) Inventors: John SOLUM, Houston, TX (US); Oriol FALIVENE ALDEA, Houston, TX (US); Pedram ZARIAN, Houston, TX (US); David Lawrence KIRSCHNER, Houston, TX (US); Neal Christian AUCHTER, Houston, TX (US); Antonino CILONA, Amsterdam (NL)

(21) Appl. No.: 17/907,751

(22) PCT Filed: Mar. 23, 2021
(86) PCT No.: PCT/EP2021/057401

§ 371 Date: Aug. 29, 2022

Related U.S. Application Data
(60) Provisional application No. 63/000,009, filed on Mar. 26, 2020.

(51) Int. Cl. G06T 7/10; G06V 20/70

(52) U.S. Cl. CPC G06T 7/10; G06V 20/70

(57) ABSTRACT

A method for predicting an occurrence of a geological feature in a geologic core image uses a backpropagation-enabled segmentation process trained by inputting multiple training geologic core images and a set of associated labels of geological features, iteratively computing a prediction of the probability of occurrence of the geological feature for the training images and adjusting the parameters in the backpropagation-enabled segmentation model until the model is trained. The trained backpropagation-enabled segmentation model is used to predict the occurrence of the geological features in non-training geologic core images. Geological features to be predicted with this method include structural features (such as veins, fractures, bedding contacts, etc.), and stratigraphic features (such as lithologic types, sedimentary structures, sedimentary facies, etc.).

### FIELD OF THE INVENTION

The present invention relates to backpropagation-enabled processes, and in particular, to a method for training a backpropagation-propagation segmentation process to identify the occurrence of geological features from images of geologic cores.

### BACKGROUND OF THE INVENTION

An important method in hydrocarbon exploration and production is the description of geologic cores extracted from the subsurface. Core descriptions are used to understand, map and predict the different geological elements needed to find hydrocarbon accumulations in the subsurface that can be produced economically. In addition, core descriptions are also important to calibrate other types of data that measure physical properties of geological materials in the subsurface, such as well logs, borehole image logs and seismic data.

Conventionally, experienced geoscientists visually inspect cores and/or core images to characterize and describe those cores. This process is time consuming and prone to individual bias and/or human error. As a result, the core descriptions may have inconsistent quality and format. Describing a geologic core may take an experienced geologist, for example, weeks or more to complete, depending, for example, on a sample's physical length and geological complexity.

In an effort to automate the process, Thomas et al. (“Automated lithology extraction from core photographs” First Break 29:103-109; June 2011) uses an object-based image analysis that includes image segmentation and a knowledge-based design including a classification algorithm for evaluating the likelihood that an interval of the image belongs to one of a number of defined classes. In a knowledge-based design, a human expert trains a classification algorithm by manually selecting representative objects for specified lithology classes (sand, shale, carbonate cements and no-core regions). The classification of the image objects is performed by supervised classification, based on fuzzy logic.

However, machine learning processes offer the opportunity to speed up time-intensive core description processes and avoid having to explicitly formulate rules for each geological feature to be distinguished.

US2017/0286802A1 (Mezghani et al.) describes a process for automated descriptions of core images. The process involves pre-processing an image of a core sample to fill in missing data and to normalize image pixel attributes. Several statistical attributes are computed from the intensity color values of the image pixels (such as maximum intensity, standard deviation of the intensity or intensity contrasts between neighboring pixels). These statistical attributes capture properties related to the color, texture, orientation, size and distribution of grains. These attributes are then compared to descriptions made by geologists in order to associate certain values or ranges for each of the attributes to specific classes in order to describe a core. Application to non-described cores then implies computing the statistical attributes and using the trained model to produce an output core description.

Conventional techniques, such as described by Mezghani et al. are limited by the fact that the attributes computed are very simple and therefore difficult to transfer to a variety of geological features with multiple appearances. It is also limited by the fact that each type of geologic feature to be described requires a specific combination of attributes and is therefore difficult to generalize. Further, this technique does not use a backpropagation-enabled process to adjust the training classifier based on the statistical attributes.

Pires de Lima et al. (“Deep convolutional neural networks as a geological image classification tool” The Sedimentary Record 17:2:4-9; 2019; “Convolutional neural networks as aid in core lithofacies classification” Interpretation SF27-SF40; August 2019; and “Convolutional Neural Networks” American Association of Petroleum Geologists Explorer, October 2018) describe a backpropagation-enabled process using a convolutional neural network (CNN) for image classification, which they applied to the classification of images from microfossils, geological cores, petrographic photomicrographs, and rock and mineral hand sample images. Pires de Lima use a model trained with millions of labelled images and transfer learning to classify geologic images. The classification developed by this method is based on associating an image to a single label of a geological feature, and therefore the predictions obtained by this method can only infer a single label to areas of the core images composed of multiple pixels (typically a few hundred pixels by a few hundred pixels).

Generally, these conventional classification techniques oversimplify a core image into only a few images. This approach is limited to handle core images with multiple heterogeneity scales in which some of the heterogeneity scales at finer resolution cannot be properly captured with only a single label for an area of the image of a few hundred pixels by a few hundred pixels. Therefore, detailed resolution of the geological features in the core image is lost by this oversimplification, thereby reducing the value of the output core description.

There is a need for a method for training a backpropagation-enabled process for identifying the occurrence of geological features that does not rely on precomputed statistical attributes, is capable of producing descriptions of core images at the same resolution as the core images, and is general enough that the trained model can be applied to cores obtained from new wells in or other geographical areas than the cores used for training the method. This will improve conventional processes by improving resolution, accuracy, efficiency and transferability of the method.

### SUMMARY OF THE INVENTION

According to one aspect of the present invention, a method for predicting an occurrence of a geological feature in a geologic core image, the method comprising the steps of: (a) providing a trained backpropagation-enabled segmentation process, wherein a backpropagation-enabled segmentation process trained by (i) inputting a training geologic core image with an image input dimension of at least two into a backpropagation-enabled segmentation process; (ii) inputting a set of labels of geological features associated with the training geologic core image into the backpropagation-enabled segmentation process, wherein the set of labels has a label input dimension equal to or less than the image input dimension; and (iii) iteratively computing a prediction of the probability of occurrence of the geological feature for the training geologic core image and adjusting of the parameters in the backpropagation-enabled segmentation model, thereby producing the trained backpropagation-enabled segmentation process; and (b) using the trained backpropagation-enabled segmentation process to predict the occurrence of the geological feature in a non-training geologic core image of input dimension of at least two.

### BRIEF DESCRIPTION OF THE DRAWINGS

The method of the present invention will be better understood by referring to the following detailed description of preferred embodiments and the drawings referenced therein, in which:

FIG. 1 illustrates an embodiment of a first aspect of the method of the present invention for training a backpropagation-enabled segmentation process for structural geological features;

FIG. 2 illustrates another embodiment of the first aspect of the method of the present invention for training a backpropagation-enabled segmentation process for stratigraphic geological features;

FIG. 3 illustrates an embodiment of a second aspect of the method of the present invention for using the trained backpropagation-enabled segmentation process of FIG. 1 to predict structural geological features of a non-training core image; and

FIG. 4 illustrates another embodiment of the second aspect of the method of the present invention for using the trained backpropagation-enabled process of FIG. 2 to predict stratigraphic geological features of a non-training core image.

### DETAILED DESCRIPTION OF THE INVENTION

The present invention provides a method for predicting an occurrence of a geological feature in a geologic core image. Geological features can include, but are not limited to, structural geological features, stratigraphic geological features, and combinations thereof. The trained backpropagation-enabled segmentation process may be used to produce a core description in a time-efficient manner with better resolution and accuracy than conventional processes. For example, a core description prepared by manual inspection of core images may take a skilled interpreter, for example, weeks or more to complete, depending, for example, on a sample's physical length and geological complexity, while a core description produced from a trained backpropagation-enabled segmentation process, in accordance with the present invention, may take only a few minutes of computer time, with increased consistency.

Examples of structural geological features include, without limitation, veins, fractures, bedding contacts, mechanical units' boundaries, stylolites, discontinuities (such as, for example, fracture-enhanced vugs), changes in density, deformed and undeformed regions, deformation bands, and the like.

Examples of stratigraphic geological features include, without limitation, lithologic types, sedimentary structures, sedimentary facies, sedimentary textures, bioturbation types, diagenetic alterations, and the like. Preferably, the lithology features include sandstone, carbonates, shale and combinations and intermediates thereof. Advantageously, the method of the present invention can provide a prediction of more complex lithologies, for example, mixtures of sand and shale or different types of carbonate rock types.

Structural features and stratigraphic features control the capacity of the rocks in the subsurface to store and produce hydrocarbons, and therefore consistent and quick descriptions of these rocks can be particularly useful information for those skilled in the art of hydrocarbon exploration and/or production.

### Backpropagation-Enabled Process

The method of the present invention includes the step of providing a trained backpropagation-enabled segmentation process.

Examples of backpropagation-enabled processes include, without limitation, artificial intelligence, machine learning, and deep-learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled processes, even if not expressly named herein.

A preferred embodiment of a backpropagation-enabled process is a deep learning process, including, but not limited to, a convolutional neural network.

The backpropagation-enabled process may be supervised, semi-supervised, or a combination thereof. In one embodiment, a supervised process is made semi-supervised by the addition of an unsupervised technique. As an example, the unsupervised technique may be an auto-encoder step.

In a preferred embodiment, the backpropagation-enabled process is a supervised segmentation process. Preferably, the supervised segmentation process comprises the steps of localizing, identifying and labeling classes of the geological feature.

In accordance with the present invention, the method for training the backpropagation-enabled segmentation process involves inputting a training geologic core image, with an input dimension of at least two, and a corresponding set of labels describing the geologic features at each pixel of the geologic core image, into the backpropagation-enabled segmentation process. The input training geologic core image and the set of labels may be a two-dimensional image, a three-dimensional image, and combinations thereof.

### Training Images and Associated Labels

Training core images may be collected in a manner known to those skilled in the art from real geologic core images of slabbed cores, whole cores, circumferential core images, and combinations thereof. Core images are typically produced from core samples obtained from a hydrocarbon-containing formation or other formations of interest. In a preferred embodiment, a core sample of the rock is obtained by coring a portion of the formation from within a well in the formation as a whole core. In another embodiment, the cores can be collected from drilling small holes on the side of the wellbore; these are known as side-wall cores.

The core samples should be of sufficient size to obtain a two-dimensional or three-dimensional image of sufficient volume and resolution at the scale that the image is generated. In particular, the core sample should be of sufficient size such that characteristics of the bulk sample predominate over the characteristics of the edges of the sample at the scale or field of view of the image to be generated.

Images of geologic cores can also be collected by an indirect or direct measurement of a physical or chemical property of the geologic core, including without limitation, computed tomography (“CT”) scans, acoustic microscopy, magnetic resonance imaging, density, gamma ray, or other indirect measurement of physical properties measured at high-resolution across the core, such that an image can be assembled, and the like. These indirect or direct measurements of physical or chemical properties can be collected directly, for example, from a three-dimensional volume representing the entire core sample. These volumes can be sectioned in an arbitrary plane to obtain a two-dimensional image or by using directly parts or the entire volume.

Preferably, the training geologic core image comprises at least one color channel, for example, a grayscale image. More preferably, a set of training geologic core images has at least three-color channels, with or without brightness, transparency or alpha channels, including, without limitation, such as RGB, RGB-A, CIEXYZ, CIELAB, CMYK, HSL and HSV color spaces. Another example is described in U.S. Pat. No. 10,249,080B2 (Griffith). Most preferably, the set of training core images has the same color channels for each image.

Preferably, the color channel is derived from visible light. In another embodiment, the color channel is derived from white light, ultra-violet light, and/or a non-visible portion of the electromagnetic spectrum. Multiple color channels can also be combined in order to reduce the data dimensions for training the backpropagation-enabled segmentation process.

In a preferred embodiment, the training geologic core image may be processed to reduce noise, image artefacts, or to normalize or equalize color spectrum. Image artefacts may include, for example, processing and/or storage artefacts, such as wood from crates, plug holes, plugs holes filled with plastic, foam or other material, markings applied with ink, paint, white-out, pencil, and the like. Noise may be filtered from the image, for example, but not limited to, by using a local mean filter to reduce noise. Imaging artifacts, which may be predominant at the outer edges of the acquired image, may be reduced by processing the image while excluding the outer edges of the image.

In order to be suitable for training the backpropagation-enabled segmentation processes, each geologic core image used for training has an associated set of labels that describe the presence or absence for each geological feature for each pixel in the image.

In accordance with the method of the present invention, a set of labels that describe the presence or absence of a geological feature is associated with each training geologic core image and is input into the backpropagation-enabled segmentation process. The labels may have a label input dimension of at least two dimensions, and equal to or less than the image input dimension.

The set of labels can be expressed as categorical or a categorical ordinal array.

Since obtaining the associated labels for each of the images is done manually and therefore is time consuming the information from the geologic core images may be augmented with numerical simulations of some geological features blended with the original image, and therefore automatically obtain the associated labels for those simulated geological features without manual labelling.

In another embodiment the geologic core images can be replaced, in whole or in part, by numerically generated synthetic images and their numerically derived associated labels in order to avoid manual labelling.

### Image Resolution and Storage

The training geologic core images have a resolution. The pixels and/or voxels of the core image define the resolution of the training image. If the training image is two-dimensional then the training image is comprised of a plurality of pixels, where the area defined by each pixel represents a maximum resolution of the training image. If the training image is three-dimensional then the training image is comprised of a plurality of voxels, where the volume defined by each voxel represents a maximum resolution of the training image. The resolution of the training image should be selected to provide a pixel and/or voxel size at which the desired geological features are sufficiently resolved and at which a sufficient field of view is provided so as to be representative of the core sample for a given geological feature to be analyzed. The image resolution is chosen to be detailed enough for feature identification while maintaining a sufficient field of view to avoid distortions of the overall sample. In a preferred embodiment, the image resolution is selected to require as little computational power to store and conduct further computational activity on the image while providing enough detail to identify a geological feature based on a segmented image.

In one embodiment of the present invention, the training geologic core images are stored and/or obtained from a cloud-based tool adapted to store images. For example, the cloud-based tool may be adapted to store two-dimensional projection images from a three-dimensional imaging technology such as CT scans. The cloud-based tool is advantageously adapted to process two-dimensional projection images to produce a reconstructed three-dimensional image. Preferably, the cloud-based tool is also adapted to store the resulting image.

In a preferred embodiment, the image input dimension of the training images is at least 2 and the prediction dimension is at least 2.

In another preferred embodiment, the image input dimension of the training images is at least 3 and the prediction dimension is 2 or 3 dimensions.

### Backpropagation-Enabled Segmentation Process Training

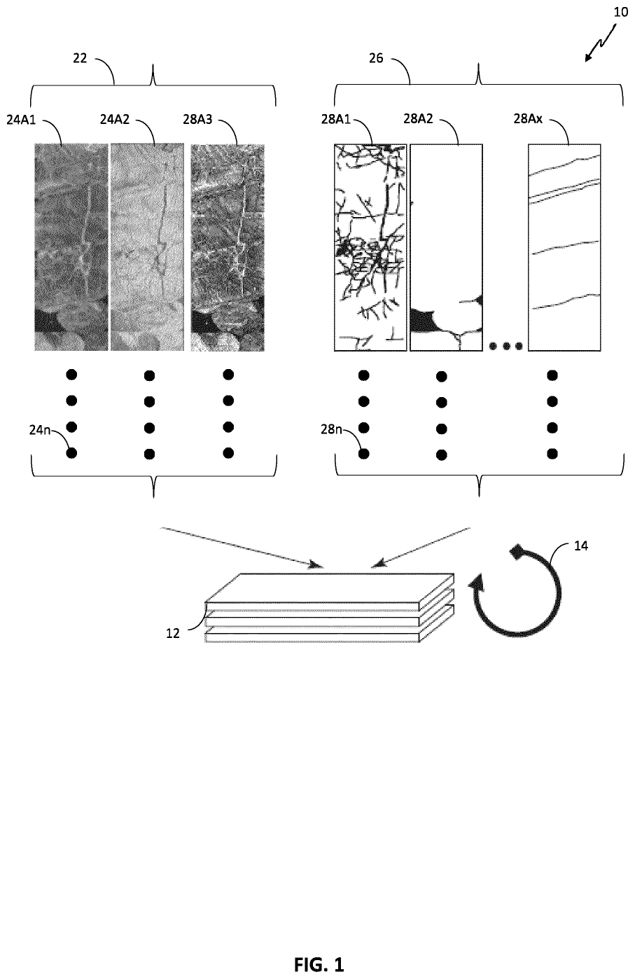

Referring now to the drawings, FIG. 1 illustrates a preferred embodiment of a first aspect of the method of the present invention 10 for training a backpropagation-enabled process 12 for structural geological features. In this embodiment, a set 22 of training core images 24A-24n of structural geological features are inputted to the backpropagation-enabled process 12, together with an associated set 26 of labels 28A-28n describing structural geological features. In the simplified drawing, the training core images 24A-24n are two-dimensional and the training set 22 comprises color channels for the same image 24A representing red (24A1), green (24A2) and blue (24A3).

The set 22 is simplified for illustrative purposes only. The drawing shows only one image being input but, it will be understood that, in a preferred embodiment, a plurality of images (for example, thousands or more) are inputted for training the backpropagation-enabled segmentation process in order to improve the results. For example, the set 22 may include a plurality of representations of the same structural geological feature and/or additional structural geological features. It will be understood from the preceding discussion that other color channels may be used for the set 22 of training core images 24A-24n. It will also be understood from the discussion herein that the set of images 22 may be comprised of two-dimensional images, three-dimensional images, and combinations thereof.

The labels 28A-28n correspond to the presence (black color) or absence (white color) for each structural geological feature in each pixel in the training image set 22. In the illustrated example, label 28A1 is associated with veins or fractures, label 28B2 is associated with non-core discontinuities, and label 28Ax is associated with bedding planes.

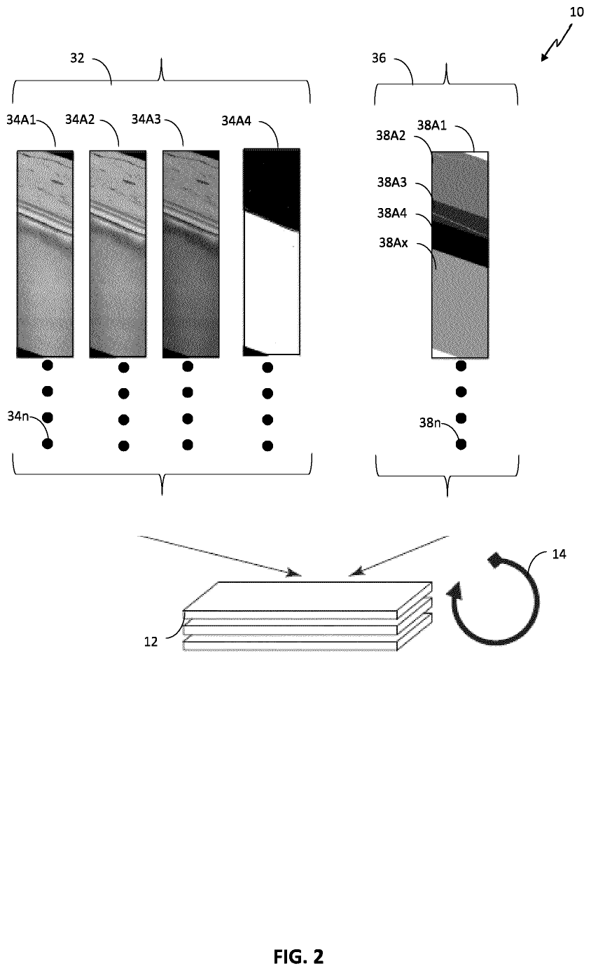

FIG. 2 illustrates another preferred embodiment of a first aspect of the method of the present invention 10 for training a backpropagation-enabled process 12 for stratigraphic geological features. In this embodiment, a set 32 of training core images 34A-34n of stratigraphic geological features are inputted to the backpropagation-enabled process 12, together with an associated set 36 of labels 38A-38n describing stratigraphic geological features. In this simplified drawing, the training core images 34A-34n are two-dimensional and the training set 32 of comprises color channels for the same image 34A representing red (34A1), green (34A2), blue (34A3) and the response of the core sample to ultraviolet light (34A4).

The set 32 is simplified for illustrative purposes only. The drawing shows only one image being input but, it will be understood that, in a preferred embodiment, a plurality of images (for example, thousands or more) are inputted for training the backpropagation-enabled segmentation process in order to improve results. For example, the set 32 may include a plurality of representations of the same stratigraphic geological feature and/or additional stratigraphic geological features. It will be understood from the preceding discussion that other color channels may be used for the set 32 of training core images 34A-34n, and preferably include different images from one or more core samples. It will also be understood from the discussion herein that the set of images 32 may be comprised of two-dimensional images, three-dimensional images, and combinations thereof.

The labels 38A-38n correspond to the dominant stratigraphic geological features in each pixel in the training images 34A-34n. In the illustrated example, label 38A1 is associated with areas of no core in the image, label 38A2 is associated with non-fluorescing debritic lithology, labels 38A3 and 38A4 are associated with non-fluorescing mudstone-dominated lithofacies, and label 38Ax is associated with strongly fluorescing sandstone-dominated lithofacies.

Further, as discussed herein, the training process may include a combination of images 24A-24n with associated labels 28A-28n for structural geological features and images 34A-34n with associated labels 38A-38n for stratigraphic geological features.

Referring to both FIGS. 1 and 2, the training images 24A-24n, 34A-34n and the associated labels 28A-28n, 38A-38n are inputted to the backpropagation-enabled segmentation process 12. The process trains a set of parameters in the backpropagation-enabled segmentation model 12. The training is an iterative process, as depicted by the arrow 14, in which the prediction of the probability of occurrence of the geological feature is computed, this prediction is compared with the input labels 28A-28n, 38A-38n, and then through backpropagation processes the parameters of the model 12 are updated.

The iterative process involves inputting a variety of images of the geological features, together with their associated labels during an iterative process in which the differences in the predictions of the probability of occurrence of each geological feature and the labels associated to the images of cores are minimized. The parameters in the model are considered trained when a pre-determined threshold in the differences between the probability of occurrence of each geological feature and the labels associated to the images is achieved, or the backpropagation process has been repeated a predetermined number of iterations.

In accordance with the present invention, the prediction of the probability of occurrence has a prediction dimension of at least 1. In the backpropagation segmentation process, the prediction of the occurrence of a geological feature is the same as the image resolution as the input data or a subset thereof.

In a preferred embodiment, the training step includes validation and testing. Preferably, results from using the trained backpropagation-enabled segmentation process are provided as feedback to the process for further training and/or validation of the process.

### Inferences with Trained Segmentation Process

Once trained, the backpropagation-enabled segmentation process is used to predict the occurrence of geological features. In one embodiment, the probability of occurrence is depicted on a grayscale with 0 (black) to 1 (white). Alternatively, a color scale can be used.

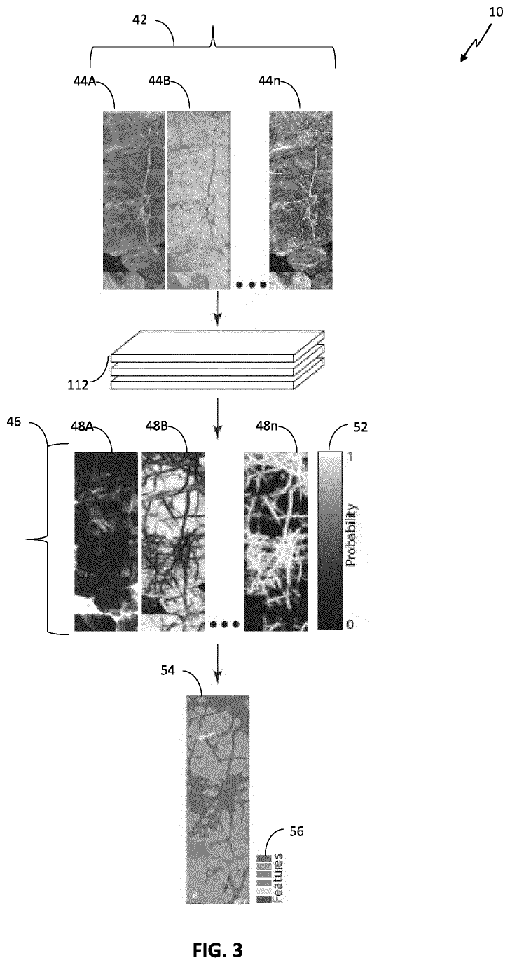

Turning now to FIG. 3, a set 42 of non-training core images 44A-44n, in this case comprising multiple input color channels for the same structural image, are fed to a trained backpropagation-enabled segmentation process 112. In the embodiment shown in FIG. 3, the non-training core images 44A-44n represent red (44A), green (44B) and blue (44n) input color channels. Preferably, the non-training core images have the same color channels as the training core images.

The set 42 is simplified for illustrative purposes only and would not normally be the same image as was used for training. It will be understood from the preceding discussion that, like the training images, other color channels may be used for the set 42 of non-training core images 44A-44n. It will also be understood from the discussion herein that the set of images 42 may be comprised of two-dimensional images, three-dimensional images, and combinations thereof.

A set 46 of structural geological feature predictions 48A-48n are produced showing the probability of occurrence 52. For example, in prediction 48A, the probability of the presence of general discontinuities is depicted. In prediction 48B, the probability of the presence of undeformed regions is depicted. And, in prediction 48n, the probability of the presence of a fracture or vein is depicted.

In a preferred embodiment, the set 46 of structural geological feature predictions 48A-48n are combined to produce a combined prediction 54. Various structural features are illustrated by a color-coded bar 56.

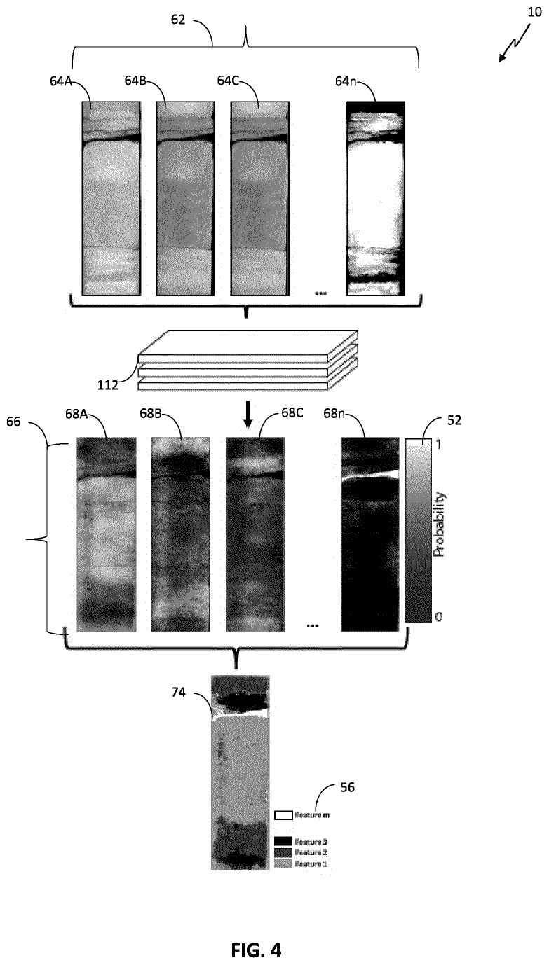

In FIG. 4, a set 62 of non-training core images 64A-64n are fed to a trained backpropagation-enabled segmentation process 112. In the embodiment shown in FIG. 4, the non-training core images 64A-64n represent color channels red (64A), green (64B), blue (64C) and the response of the core sample to ultraviolet light (64n).

It will be understood from the preceding discussion that, like the training images, other color channels may be used for the set 62 of non-training core images 64A-64n. It will also be understood from the discussion herein that the set of images 62 may be comprised of two-dimensional images, three-dimensional images, and combinations thereof

A set 66 of stratigraphic geological feature predictions 68A-68n are produced showing the probability of occurrence 52. For example, 68A represents the probability of occurrence of strongly fluorescing sandstone-dominated lithofacies, 68B represents the probability of non-fluorescing mudstone-dominated lithofacies, 68C represents the probability of partially fluorescing muddy-sandstone-dominated lithofacies, and 68n represents the probability of occurrence of areas of no core in the image.

In a preferred embodiment, the set 66 of stratigraphic geological feature predictions 68A-68n are combined to produce a combined prediction 74. Various stratigraphic features are illustrated by a color-coded bar 56.

While preferred embodiments of the present invention have been described, it should be understood that various changes, adaptations and modifications can be made therein within the scope of the invention(s) as claimed below.

What is claimed is:

1. A method for predicting an occurrence of a geological feature in a geologic core image, the method comprising the steps of:
(a) providing a trained backpropagation-enabled segmentation process, wherein a backpropagation-enabled segmentation process trained by
i. inputting a training geologic core image with an image input dimension of at least two into a backpropagation-enabled segmentation process;
ii. inputting a set of labels of geological features associated with the training geologic core image into the backpropagation-enabled segmentation process, wherein the set of labels has a label input dimension equal to or less than the image input dimension; and
iii. iteratively computing a prediction of the probability of occurrence of the geological feature for the training geologic core image and adjusting of the parameters in the backpropagation-enabled segmentation model, thereby producing the trained backpropagation-enabled segmentation process; and
(b) using the trained backpropagation-enabled segmentation process to predict the occurrence of the geological feature in a non-training geologic core image of input dimension of at least two.

2. The method of claim 1, wherein the geological feature is selected from the group consisting of structural geological features, stratigraphic geological features, and combinations thereof.

3. The method of claim 2, wherein the structural geological feature is selected from the group consisting of veins, fractures, bedding contacts, mechanical units' boundaries, stylolites, discontinuities, changes in density, deformed regions, undeformed regions, deformation bands, and combinations thereof.

4. The method of claim 2, wherein the stratigraphic geological feature is selected from the group consisting of lithologic types, sedimentary structures, sedimentary facies, bioturbation types, diagenetic alterations, and combinations thereof.

5. The method of claim 1, wherein the image input dimension is at least 2, and the prediction dimension is 1 or 2.

6. The method of claim 1, wherein the image input is at least 3, and the prediction dimension is selected from the group consisting of 1, 2 or 3 dimensions.

7. The method of claim 1, wherein the training geologic core image is derived from photographs taken using white light, ultra-violet light, a non-visible portion of the electromagnetic spectrum, and combinations thereof.

8. The method of claim 1, wherein the training geologic core image is selected from a slabbed core image, a circumferential core image, and combinations thereof.

9. The method of claim 1, wherein the training geologic core image is derived from an indirect measurement of physical or chemical properties of a geologic core.

10. The method of claim 1, wherein the training geologic core image is augmented with numerical simulations of the geological feature.

11. The method of claim 1, wherein the training geologic core image is selected from the group consisting of images of real geologic cores, images of real geologic cores modified with numerical simulations of a geological feature, synthetic images from numerical simulations, and combinations thereof.

12. The method of claim 1, wherein the backpropagation-enabled segmentation process is a deep-learning supervised-segmentation process.

13. The method of claim 1, wherein step (b) comprises the steps of:
i. inputting a set of non-training geologic core images into the trained backpropagation-enabled segmentation process;
ii. predicting a set of probabilities of occurrence of the geological feature; and
iii. producing a combined prediction based on the set of probabilities of occurrence.

14. The method of claim 1, wherein a result of step (b) is used to produce a set of predicted labels to further train the backpropagation-enabled segmentation process.
